(19) United States
(12) Patent Application Publication
(10) Pub. No.: US 2010/0079266 A1
(43) Pub. Date: Apr. 1, 2010

(54) MOTORCYCLE ACCIDENT WARNING ALARM

(76) Inventor: Richard K. Holt, Naples, FL (US)

Correspondence Address: EDWARD M. LIVINGSTON, PA, 963 TRAIL TERRACE DRIVE, NAPLES, FL, 34103, US

(21) Appl. No.: 12/241,107

(22) Filed: Sep. 30, 2008

(51) Int. Cl. B60Q 1/00; G08B 21/00

(52) U.S. Cl. 340/425.5; 340/440; 340/540; 340/436

(57) ABSTRACT

A motorcycle safety warning alarm (1) wherein an at least one audible and/or visual alarm (22) indicates when a motorcycle (18) has been involved in an accident and has tipped over. A tipping sensor (2) is provided having a V-shaped housing (15) with a predetermined amount of mercury (16) located therein and a plurality of sensor wire probes (17) located on opposite ends of the V-shaped housing. A time-delay (3) feature allows for minor crashes to occur wherein the motorcycle safety warning alarm will not start for a predetermined amount of time, thereby giving the rider time to return the motorcycle to an upright position. If the motorcycle is not returned to the upright position after within the predetermined amount of time, at least one audible and/or visual alarm will activate. The at least one audible and/or visual alarm may include a flashing headlight (8), a flashing taillight (9), flashing blinkers (10, 11), a honking horn (6), a GPS transmitter (7), etc.

### BACKGROUND OF THE INVENTION

This invention relates to a motorcycle accident warning alarm, more particularly a warning alarm that will warn third parties that a motorcycle accident has occurred and will alert third parties to the location of that accident.

Motorcycles are constructed so as to withstand turns wherein the angle of the motorcycle in relation to the road or ground surface is less than ninety degrees. However, when a motorcycle rider has an accident or wipes out on a motorcycle, the motorcycle most often ends up tipped over on its side. If the rider is traveling through hills or mountains, the rider may crash over the edge of the hill or mountain and become lost making it difficult for a rescuer to find the rider. The same holds true for roads having woods or heavy brush on the sides where if a rider and motorcycle go off the road, they would not be visible from the road. In additional concern is that if the rider crashes during the night in unlit or poorly lit areas and the motorcycle and rider are laying in the middle of the road, oncoming traffic may not see the wreck until it is too late.

Thus, a need exists for a motorcycle accident warning alarm which will warn oncoming traffic and other third parties to the fact that a motorcycle accident has taken place and signal oncoming traffic and other third parties to the location of that accident.

The relevant patents of prior art includes the following references:

| Patent/Ser. No. | Inventor | Issue/Publication Date |
|---|---|---|
| 7,011,177 | Machida et al. | Mar. 14, 2006 |
| 2005/0161274 | Tsuruta | Jul. 28, 2005 |
| 6,938,717 | Gaudiano | Sep. 06, 2005 |
| 6,941,206 | Hasegawa et al. | Sep. 06, 2005 |
| 6,587,042 | Tabata et al. | Jul. 01, 2003 |
| 6,268,794 | Tzaney | Jul. 31, 2001 |
| 6,034,594 | Gray | Mar. 07, 2000 |

### SUMMARY OF THE INVENTION

The primary object of the present invention is to provide a motorcycle accident warning alarm which alerts third parties that a motorcycle accident has occurred.

A further object of the present invention is to provide a motorcycle accident warning alarm which warns oncoming traffic that a motorcycle accident has occurred and to use caution.

Another object of the present invention is to provide a motorcycle accident warning alarm which alerts third parties to the location of a motorcycle after a motorcycle accident has occurred.

A further object of the present invention is to provide a motorcycle accident warning alarm which alerts a user that a motorcycle has tipped over while in the parked position.

The present invention fulfills the above and other objects by providing a motorcycle accident warning alarm wherein an audible and/or visual alarm indicates when the motorcycle has been involved in an accident and has tipped over. An angle sensor is provided having a V-shaped housing with a predetermined amount of mercury located therein and a plurality of sensor wire probes located on opposite ends of the housing. The motorcycle accident warning alarm is connected to and powered by motorcycle's battery. If the motorcycle is tipped over onto its side, the mercury will move from the bottom of the inverted V-shaped housing to whichever end of the housing is at a lower elevation and make contact with the wire probes thereby completing a circuit and sending a signal to an alarm control unit which then activates an audible and/or visual alarm. The audible and/or visual alarm may include a flashing headlight, a flashing taillight, flashing blinker, honking horn, a global positioning system (GPS) transmitter, etc. A time-delay feature allows a rider a predetermined amount of time to return the motorcycle to an upright position if a minor crash has occurred or if the motorcycle accidentally tipped over while in the parked position. Alternatively, if the motorcycle is not placed into an upright position before the time delay passes, then the rider may deactivate the audible and/or visual alarms by using a manual reset button/switch. Further, features of the present invention include a motor shut-off switch, as well as an alarm control unit which deactivates various audible and/or visual alarms after a predetermined amount of time has passed and/or a drop of voltage from the motorcycle battery has occurred while keeping other audible and/or visual alarms activated thereby conserving energy from the motorcycle battery and prolonging the chance of alerting a third party to the location of an accident over a longer period of time.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is block diagram of a motorcycle accident warning alarm of the present invention;

FIG. 2 is front view of a tipping sensor of the present invention; and

FIG. 3 is a side view of a motorcycle equipped with a motorcycle accident warning alarm of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | motorcycle accident warning alarm |
| 2. | tipping sensor |
| 3. | time delay |
| 4. | alarm control unit |
| 5. | siren |
| 6. | horn |
| 7. | global positioning system (GPS) |
| | transmitter |
| 8. | head light |
| 9. | tail light |
| 10. | front blinkers |
| 11. | rear blinkers |
| 12. | electric supply from motorcycle |
| | battery |
| 13. | ground from motorcycle |
| 14. | manual reset switch/button |
| 15. | V-shaped housing |
| 16. | mercury |
| 17. | sensor wire probes |
| 18. | motorcycle |
| 19. | weatherproof housing |
| 20. | seat |
| 21. | battery |
| 22. | audible and/or visual alarm |
| 23. | impact sensor |

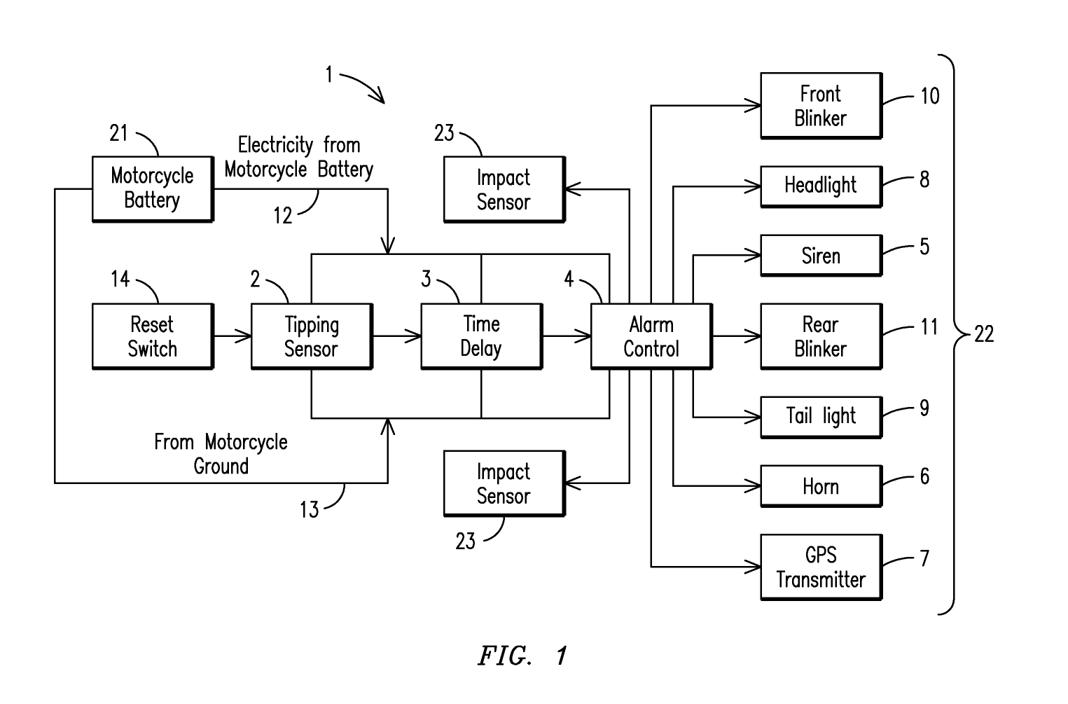

With reference to FIG. 1, a block diagram of a motorcycle accident warning alarm 1 is shown. First, a motorcycle battery 21 supplies power 12 and a ground 13 to the motorcycle accident warning alarm 1. Next, a tipping sensor 2 detects if a motorcycle has been involved in an accident and has tipped over. If the tipping sensor 2 detects that the motorcycle has tipped over then a signal will be sent to a time delay 3. The time delay 3 allows the user a predetermined amount of time to set the motorcycle upright from the tipped over position before the motorcycle accident warning alarm 1 fully activates. After the predetermined amount of time has passed, the time delay 3 will allow the signal from the tipping sensor 2 to pass on to an alarm control unit 4. The alarm control unit may then activate various audible and/or visual alarms, such as a siren 5, a horn 6, a global positioning system (GPS) transmitter 7, a flashing head light 8, a flashing tail light 9, flashing front blinkers 10, and/or flashing rear blinkers 1 1. If the motorcycle is not set upright within the predetermined amount of time and the alarm is fully activated then the user may manually deactivate the motorcycle accident warning alarm 1 with a reset switch/button 14. In addition to activating the visual and/or audible alarms 22, the alarm control unit 4 measures voltage and will deactivate various audible and/or visual alarms 22 after a predetermined drop in power being supplied to the motorcycle accident warning alarm 1 while keeping other audible and/or visual alarms 22 activated thereby conserving energy and allowing the motorcycle accident warning alarm 1 to operate as long as possible. For example, the alarm control unit 4 may be programmed to deactivate the flashing headlight 8 if a thirty percent reduction in voltage is detected while keeping the flashing blinkers 10, 11 and the horn 6 activated, thereby giving a user who has been lost a better chance of being found by a third party or a rescuer. The alarm control unit 4 may also be programmed to deactivate various audible and/or visual alarms 22 after a predetermined amount of time has passed while keeping other audible and/or visual alarms activated thereby conserving energy and allowing the motorcycle accident warning alarm 1 to operate as long as possible. The alarm control unit 4 may also be activated by at least one impact sensor 23 which detects if a motorcycle has been involved in a collision.

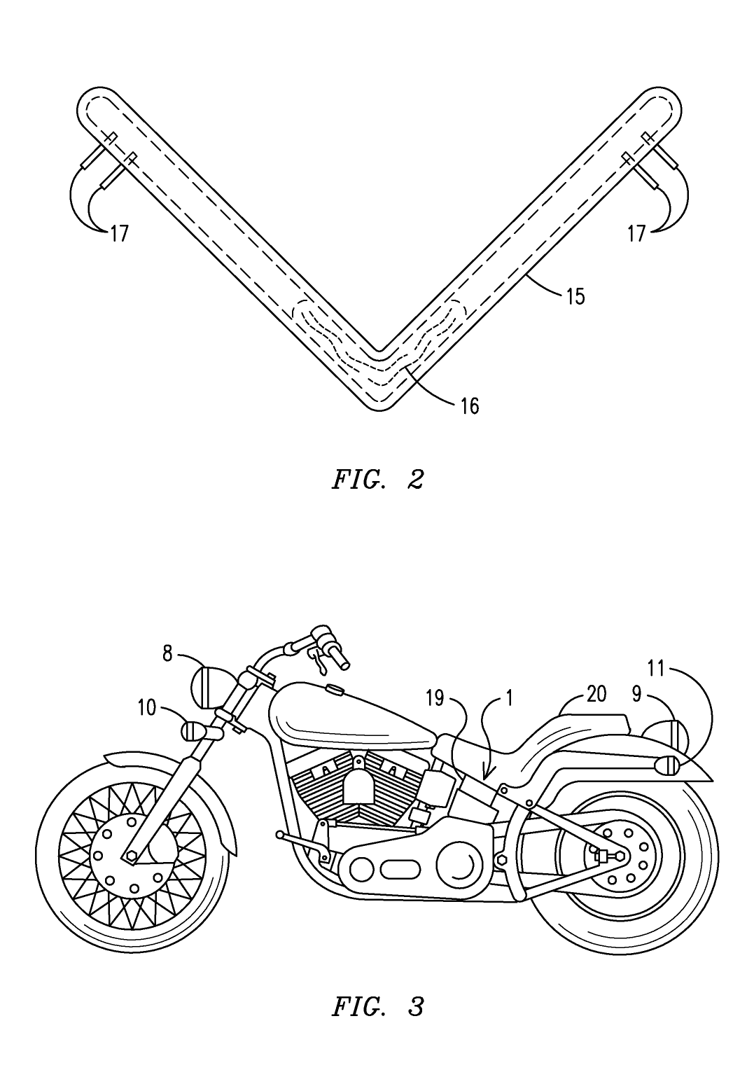

Referring to FIG. 2, a preferred embodiment of the tipping sensor of the present invention is shown. A V-shaped housing 15 having a predetermined amount of mercury 16 located therein and a plurality of sensor wire probes 17 located on opposite ends of the V-shaped housing 15 are connected to a motorcycle battery and mounted on the motorcycle so that while the motorcycle is an upright position, the mercury 16 remains at the bottom of the V-shaped housing 15. If a motorcycle is in a tipped over position, the mercury moves to whichever end of the V-shaped housing is at a lower elevation thereby making contact with the sensor wire probes and completing a circuit and sending a signal to the time delay and the alarm control unit that the motorcycle has tipped over.

Referring to FIG. 3, a side view of a motorcycle equipped with a motorcycle accident warning alarm 1 of the present invention is shown. The tipping sensor 2, time delay 3 and alarm control unit 4 and GPS transmitter are all encased in a weatherproof housing 19 which may be mounted under the seat 20 or any other available location of the motorcycle and connected to the motorcycle battery 21. The motorcycle accident warning alarm 1 is connected to a taillight 9, rear blinkers 11, a headlight 8 and front blinkers 10, all of which act as visual alarms when activated as well as a horn 6 and a siren 5 which act as audible alarms when activated.

Although a preferred embodiment of a motorcycle accident warning alarm has been disclosed, it should be understood, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A motorcycle accident warning alarm comprising:
a tipping sensor mounted on a motorcycle which detects when said motorcycle has been involved in an accident and said motor cycle has tipped over;
an alarm control unit connected to said tipping sensor which activates and/or deactivates at least one audible and/or visual alarm after receiving a signal from the tipping sensor that an accident has occurred and the motor cycle has tipped over;
at least one audible and/or visual alarm connected to the tipping sensor and alarm control unit which activates said at least one audible and/or visual alarm after said motorcycle has been involved in an accident and said motor cycle has tipped over; and
a power supply for powering said motorcycle accident warning alarm.

2. The motorcycle accident warning alarm of claim 1 further comprising:
a time delay connected to said tipping sensor for delaying the signal being sent from the tipping sensor to the alarm for a predetermined amount control unit of time allowing the motorcycle to be put into an upright position before the at least one audible and/or visual alarm is activated.

3. The motorcycle accident warning alarm of claim 2 further comprising:
a circuit board for controlling said time delay.

4. The motorcycle accident warning alarm of claim 1 further comprising:
a reset button/switch connected to said motorcycle accident warning alarm for manually resetting said sensor and deactivating said at least one audible and/or visual alarm.

5. The motorcycle accident warning alarm of claim 1 wherein:
said tipping sensor is a U-shaped housing having a predetermined amount of mercury therein; and
said tipping sensor having at least two sensor wire probes at each end of said U-shaped housing which makes contact with the mercury when a motorcycle is tipped over thereby completing an electrical circuit and activating said motorcycle accident warning alarm.

6. The motorcycle accident warning alarm of claim 1 wherein:
said tipping sensor is a V-shaped housing having a predetermined amount of mercury therein; and
said tipping sensor having at least two sensor wire probes at each end of said V-shaped housing which makes contact with the mercury when a motorcycle is tipped over thereby completing an electrical circuit and activating said motorcycle accident warning alarm.

7. The motorcycle accident warning alarm of claim 1 wherein:
said at least one audible and/or visual alarm comprises a siren.

8. The motorcycle accident warning alarm of claim 7 wherein:
said alarm control unit deactivates said siren after a predetermined amount of time thereby conserving energy and allowing said at least one alarm to operate as long as possible.

9. The motorcycle accident warning alarm of claim 7 wherein:
said alarm control unit monitors voltage and deactivates said siren after a predetermined drop in voltage thereby conserving energy and allowing said at least one alarm to operate as long as possible.

10. The motorcycle accident warning alarm of claim 1 wherein:
said at least one audible and/or visual alarm comprises a horn.

11. The motorcycle accident warning alarm of claim 10 wherein:
said alarm control unit deactivates said horn after a predetermined amount of time thereby conserving energy and allowing said at least one alarm to operate as long as possible.

12. The motorcycle accident warning alarm of claim 10 wherein:
said alarm control unit monitors voltage and deactivates said horn after a predetermined drop in voltage thereby conserving energy and allowing said at least one alarm to operate as long as possible.

13. The motorcycle accident warning alarm of claim 1 wherein:
said at least one audible and/or visual alarm comprises a headlight.

14. The motorcycle accident warning alarm of claim 13 wherein:
said alarm control unit deactivates said headlight after a predetermined amount of time thereby conserving energy and allowing said at least one alarm to operate as long as possible.

15. The motorcycle accident warning alarm of claim 13 wherein:
said alarm control unit monitors voltage and deactivates said headlight after a predetermined drop in voltage thereby conserving energy and allowing said at least one alarm to operate as long as possible.

16. The motorcycle accident warning alarm of claim 1 wherein:
said at least one audible and/or visual alarm comprises a taillight.

17. The motorcycle accident warning alarm of claim 16 wherein:
said alarm control unit deactivates said taillight after a predetermined amount of time thereby conserving energy and allowing said at least one alarm to operate as long as possible.

18. The motorcycle accident warning alarm of claim 16 wherein:
said alarm control unit monitors voltage and deactivates said taillight after a predetermined drop in voltage thereby conserving energy and allowing said at least one alarm to operate as long as possible.

19. The motorcycle accident warning alarm of claim 1 wherein:
said at least one audible and/or visual alarm comprises at least one blinker.

20. The motorcycle accident warning alarm of claim 18 wherein:
said alarm control unit deactivates said at least one blinker after a predetermined amount of time thereby conserving energy and allowing said at least one alarm to operate as long as possible.

21. The motorcycle accident warning alarm of claim 19 wherein:
said alarm control unit monitors voltage and deactivates said at least one blinker after a predetermined drop in voltage thereby conserving energy and allowing said at least one alarm to operate as long as possible.

22. The motorcycle accident warning alarm of claim 1 wherein:
said at least one alarm is connected to a Global Positioning System transmitter and alerts third parties that an accident has occurred and the motor cycle has tipped over by activating said Global Positioning System transmitter.

23. The motorcycle accident warning alarm of claim 1 further comprising:
a fuel shut-off switch connected to said tipping sensor for deactivating any flow of fuel through the engine after an accident has occurred and the motor cycle has tipped over.

24. The motorcycle accident warning alarm of claim 1 wherein:
said power supply is a motorcycle battery.

25. The motorcycle accident warning alarm of claim 1 further comprising:
at least one impact sensor which detects if the motorcycle has been involved in a collision and activates the alarm control unit if a collision is detected.
